(19) United States
(12) Patent Application Publication
(10) Pub. No.: US 2005/0285906 A1
(43) Pub. Date: Dec. 29, 2005

(54) Fluid injection device

(75) Inventor: In-Yao Lee, Shijr City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ Corporation

(21) Appl. No.: 11/135,118

(22) Filed: May 23, 2005

(30) Foreign Application Priority Data
Jun. 28, 2004 (TW) 93118757

(51) Int. Cl. B41J 2/05

(52) U.S. Cl. 347/65

(57) ABSTRACT

A fluid injection device. The device includes a substrate, a structural layer formed thereon, a manifold installed in the substrate to supply fluid, a plurality of chambers with the same length formed between the substrate and the structural layer to hold injected fluid, and a plurality of nozzles through the structural layer to inject fluid, wherein each chamber connects with the manifold by a channel and the nozzles connect to the chambers.

### BACKGROUND

The present invention relates to a semiconductor device, and more specifically to a fluid injection device.

Currently, the fluid injection technique is widely used in various products, such as ink jet printheads, fuel oil injection devices, or drug injection mechanism.

A related art fluid injection device is disclosed for example, in U.S. Pat. No. 6,102,530 and illustrated in FIG. 1. The fluid injection device comprises a silicon substrate 38, a manifold 26 to transport fluid, a plurality of chambers 14 installed on one side of the manifold 26 to hold fluid, a plurality of nozzles 18 installed on the surface of the chambers 14 to inject fluid, and injection elements 20 and 22 installed around the nozzles 18.

A fabrication process for the above chamber 14 is disclosed in the following. Referring to FIG. 2a, a substrate 38 comprising an upper protective layer 42 and a lower protective layer 44 is provided, wherein a sacrificial layer is installed between the substrate 38 and the upper protective layer 42. Subsequently, referring to FIG. 2b, the back of the substrate 38 is etched by anisotropic wet etching to form a manifold 26, exposing the sacrificial layer 40 (not shown). The sacrificial layer 40 (not shown) is then removed by HF. Finally, the substrate 38 is repeatedly etched with KOH to enlarge the vacant volume thereof, thus forming the chamber 14, as shown in FIG. 2c.

FIG. 3a shows an original chamber pattern design on a mask and FIG. 3b shows an etching result of the chambers. Referring to FIG. 3b, when the chambers 14 are formed by anisotropic wet etching, the portion 30 of the substrate isolating each chamber 14 may also be etched. As a result, various chamber lengths may be provided from the original design (as shown in FIG. 3a) because anisotropic etching has various etching rates for different crystal planes, thus resulting in cross-talk among the chambers 14. Additionally, stress may concentrate on a point, when an etching peak 31 is formed, thus deteriorating structural strength and reducing active lifetime of a device. The above situation may worsen with reduced device size.

### SUMMARY

In order to solve problems related to the conventional technology, the invention provides a fluid injection device having chambers with the same length to eliminate cross-talk while chambers are refilled with fluid.

The invention provides a fluid injection device comprising a substrate, a structural layer formed on the substrate, a manifold installed in the substrate to supply fluid, a plurality of chambers with the same length formed between the substrate and the structural layer to hold injected fluid, a plurality of channels formed between the chambers and the manifold, and a plurality of nozzles through the structural layer and connected with the chambers to inject fluid, wherein the manifold is connected to the chambers by the channels.

Based on the above device structure, when the chambers are refilled with fluid, cross-talk between adjacent chambers can be avoided due to the narrow channels between the chambers and the manifold.

The invention also provides a fluid injection device comprising a substrate, a structural layer formed on the substrate, a manifold installed in the substrate to supply fluid, a plurality of chambers formed between the substrate and the structural layer and connected with the manifold to hold injected fluid, a neck structure installed between the manifold and each chamber, and a plurality of nozzles through the structural layer, connecting the chambers to inject fluid.

The invention further provides a fluid injection device comprising, a substrate, a structural layer formed on the substrate, a manifold installed in the substrate to supply fluid, a plurality of chambers formed between the substrate and the structural layer and connected with the manifold to hold injected fluid, a neck structure installed between the manifold and each chamber, wherein the neck structures have different widths which increase as distances from the chambers to the manifold increase, and a plurality of nozzles through the structural layer, connecting the chambers to inject fluid.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross section of a fluid injection device as disclosed in U.S. Pat. No. 6,102,530.

FIGS. 2a˜2c are cross sections illustrating fabrication process of a fluid injection device as disclosed in U.S. Pat. No. 6,102,530.

FIG. 3a shows a related mask pattern.

FIG. 3b illustrates anisotropic etching performance.

FIGS. 4a˜4b are cross sections of the method of fabricating a fluid injection device of the invention.

FIGS. 4c˜4d, 5a˜5b, 6a˜6b, and 7a˜7b show various mask patterns and etching results of the invention.

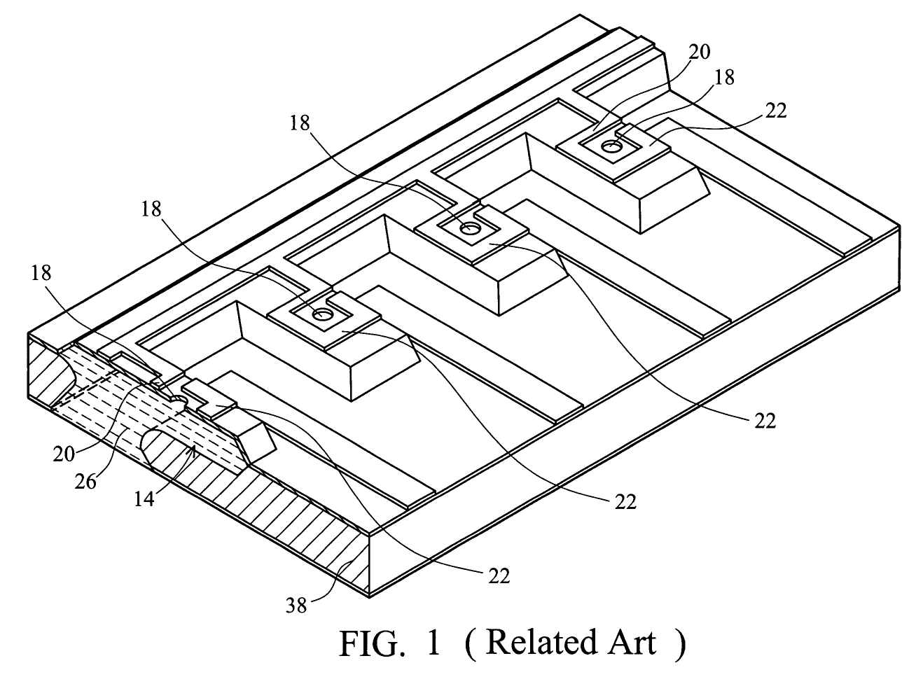

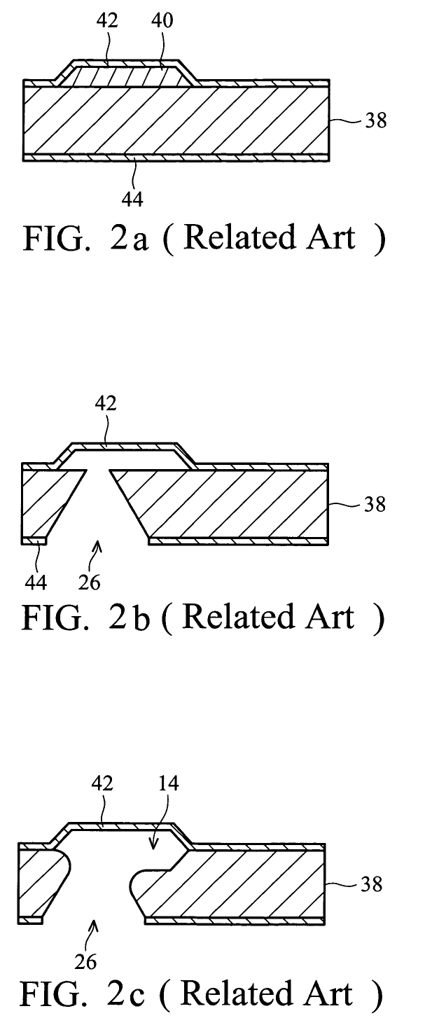

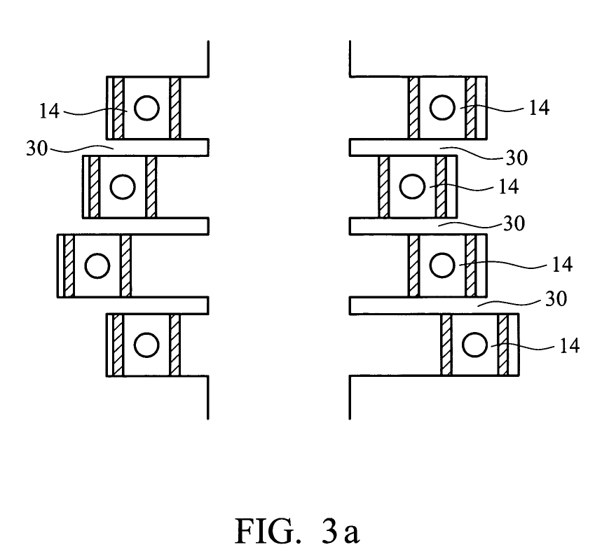

### DETAILED DESCRIPTION

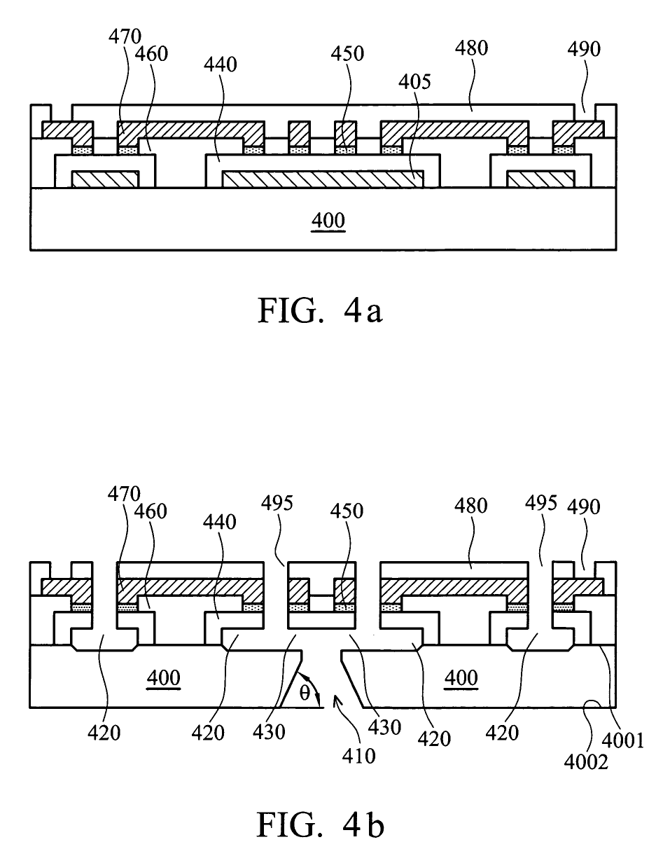

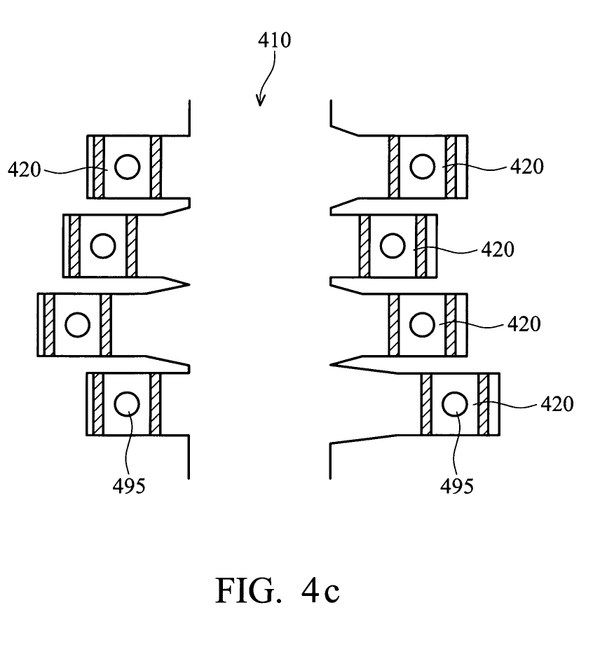

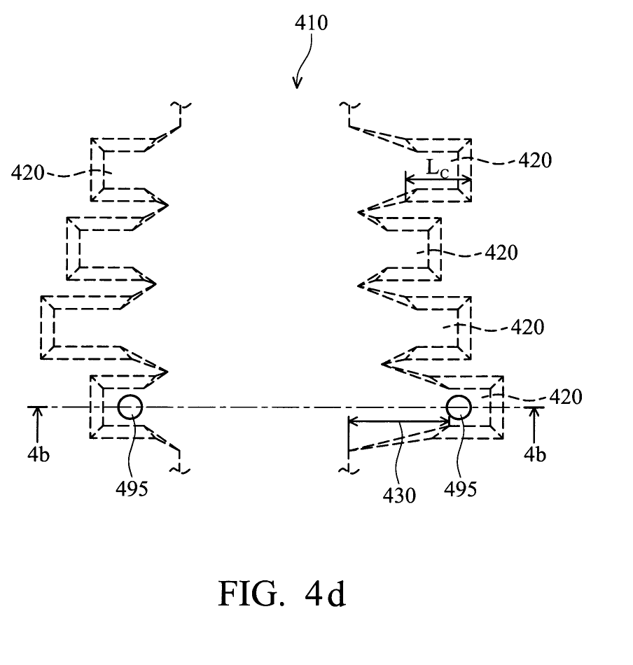

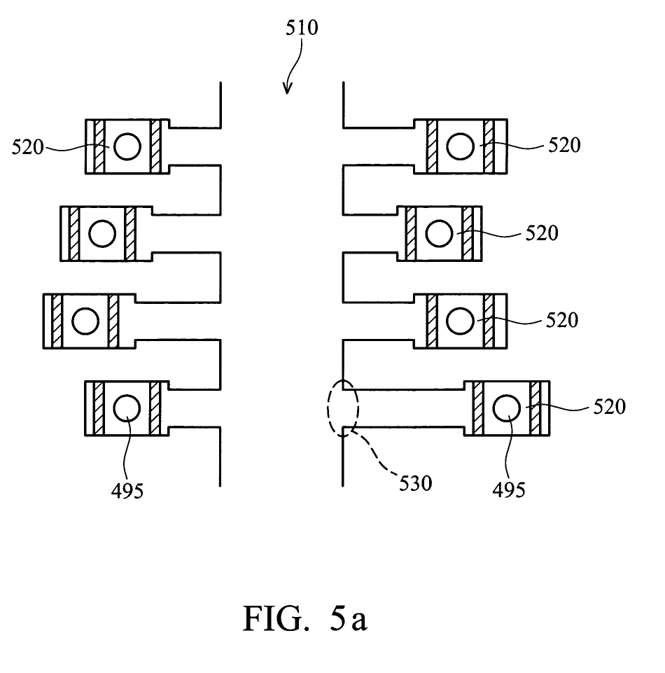

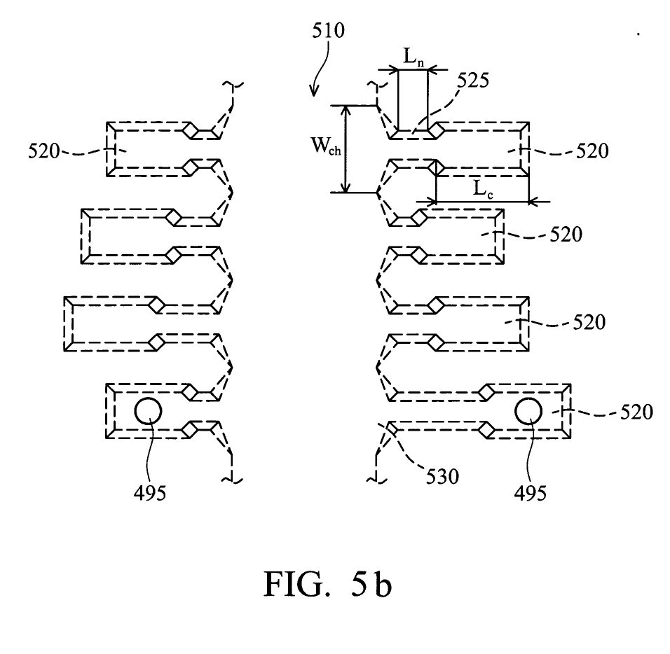

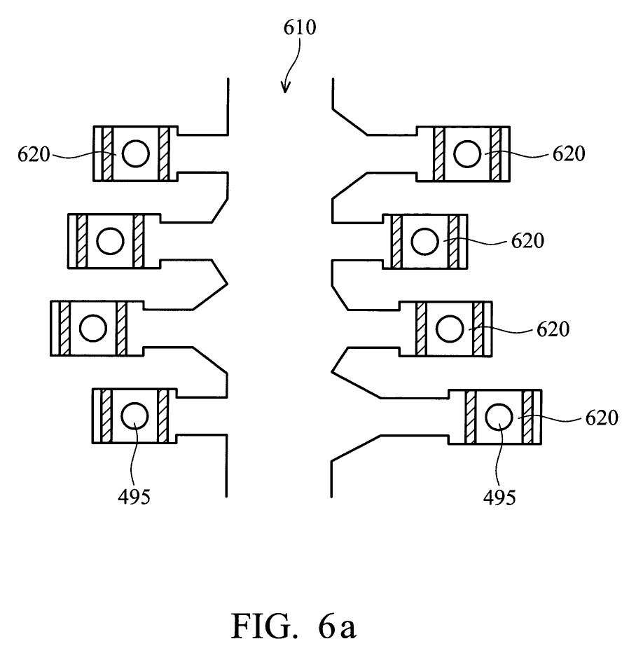

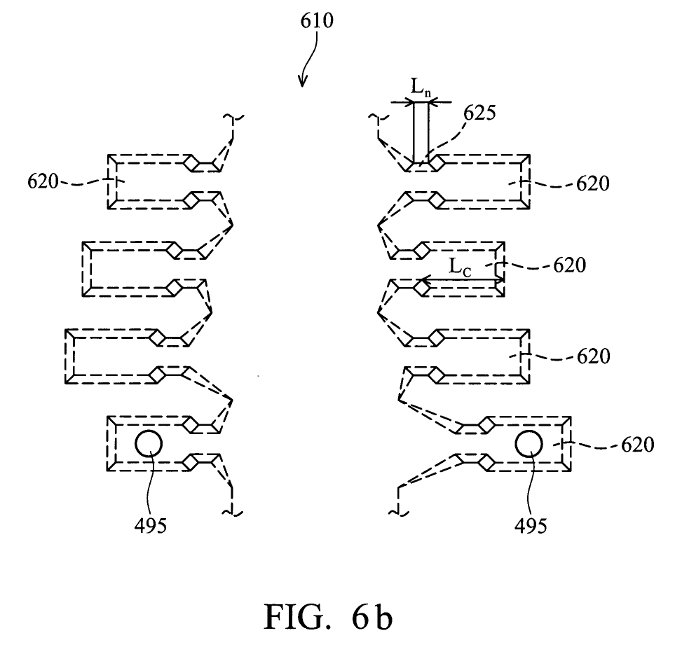

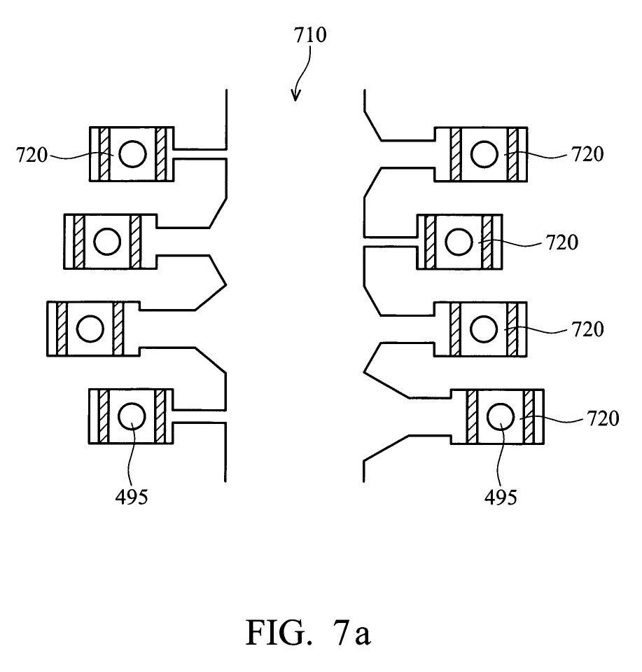

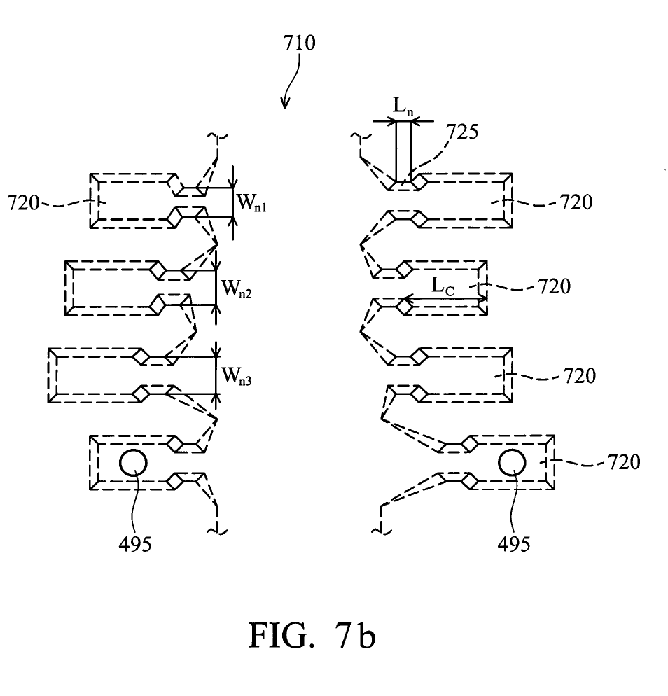

Referring to FIG. 4d, the first feature of the fluid injection device of the invention is the installation of the narrow channels 430 between the chambers 420 and the manifold 410 to form the chambers 420 with the same length (Lc).

The above device structure is illustrated in FIG. 4b (a cross section) and FIG. 4d (a top view), wherein FIG. 4b is a cross section along the tangent line 4b-4b of FIG. 4d. Referring to FIG. 4b, the fluid injection comprises a substrate 400, a manifold 410, a plurality of chambers 420, a plurality of channels 430, a structural layer 440, a resist layer 450, an isolation layer 460, a conductive layer 470, a protective layer 480, a plurality of signal transmission line contacts 490, and a plurality of nozzles 495. The manifold 410 is formed in the substrate 400, and the chambers 420 and the channels 430 are formed between the substrate 400 and the structural layer 440. Lengths of the chambers 420 are equal due to the installation of the channels 430, as shown in FIG. 4d.

The structural layer 440 covers the substrate 400, the channels 430, and the chambers 420. The resist layer 450 is installed on the structural layer 440 and on both sides of the nozzles 495. The resist layer 450 represents a plurality of fluid actuators, such as heaters, thereby driving fluid out of the nozzles 455. The isolation layer 460 covers the substrate 400, the structural layer 440, and the resist layer 450, exposing a portion of the resist layer 450 to form heater contacts. The conductive layer 470 covers the isolation layer 460 and fills heater contacts to form signal transmission lines.

The protective layer 480 covers the isolation layer 460 and the conductive layer 470, exposing a portion of the conductive layer 470 to form a plurality of signal transmission line contacts 490, thereby facilitating subsequent packaging process. A plurality of nozzles 495 are formed through the protective layer 480, the conductive layer 470, the resist layer 450, and the structural layer 440, and connected to the chambers 420.

Referring to FIG. 4a˜4d, a method of fabricating the fluid injection device is provided. First, referring to FIG. 4a, a substrate 400 such as a silicon substrate is provided. The thickness of the substrate 400 is about 625˜675 μm. Subsequently, a critical step of fabricating a patterned sacrificial layer 405 is performed. First, a sacrificial layer is formed on a first plane 4001 of the substrate 400. Next, the sacrificial layer is exposed by a mask having channel patterns and chamber patterns, as shown in FIG. 4c. Finally, a patterned sacrificial layer 405 comprising channel patterns and chamber patterns is formed after developing, wherein lengths of the chamber patterns are equal.

The sacrificial layer 405 comprises BPSG, PSG, or silicon oxide, preferably PSG. The thickness of the sacrificial layer 405 is about 1˜2 μm.

Next, a patterned structural layer 440 is formed on the substrate 400 to cover the patterned sacrificial layer 405. The structural layer 440 may be silicon oxide nitride formed by CVD. The thickness of the structural layer 440 is about 1.5˜2 μm. Additionally, the structural layer 440 is a low-stress material, and the stress thereof is about 100˜200 MPa.

Subsequently, a patterned resist layer 450 is formed on the structural layer 440, as fluid actuators, such as heaters, thereby driving fluid out of subsequently formed nozzles. The resist layer 450 comprises HfB₂, TaAl, TaN, or TiN, and is preferably TaAl.

A patterned isolation layer 460 is then formed to cover the substrate 400, the structural layer 440, and the resist layer 450, forming heater contacts. Subsequently, a patterned conductive layer 470 is formed on the isolation layer 460, and filled heater contacts to form signal transmission lines. Finally, a protective layer 480 is formed on the isolation layer 460 and the conductive layer 470, exposing the conductive layer 470, thereby forming signal transmission line contacts 490 to facilitate a subsequent packaging process.

Subsequently, referring to FIG. 4b, a series of etching steps are performed. First, a second plane 4002 of the substrate 400 is etched to form a manifold 410 by anisotropic wet etching using TMAH, KOH, or NaOH as an etching solution, exposing the sacrificial layer 405.

The narrow opening width of the manifold 410 is about 160˜200 μm, and the wide opening width thereof is about 100˜1200 μm. The included angle between the side wall of the manifold 410 and a horizontal factor is about 54.74°. Therefore, after etching, a manifold 410 with a back opening larger than a front opening is formed. Additionally, the manifold 410 connects to a fluid storage tank.

Next, the sacrificial layer 405 is removed by HF, and the substrate 400 is subsequently etched with a basic etching solution, such as KOH or NaOH, to enlarge the vacant volume thereof, forming the chambers 420 and the channels 430, wherein the channels 430 are formed between the chambers 420 and the manifold 410, and lengths (Lc) of the chambers are equal, as shown in FIG. 4d.

Finally, referring to FIG. 4b, the protective layer 480, the isolation layer 460, and the structural layer 440 are etched in order by plasma etching, chemical vapor etching, laser etching, or reactive ion etching (RIE) to form the nozzles 495 connecting to the chambers 420.

The invention provides a specific connection design such as a manifold-channel-chamber on a photomask to compensate for more rapidly etched portion of a substrate to form chambers with the same length to solve the cross-talk problem when chambers are refilled with fluid.

Referring to FIG. 5b, the second feature of the fluid injection device of the invention are the installation of the neck structures 525 between the chambers 520 and the manifold 510 to form the chambers 520 with the same length (Lc) and the formation of the same connection width (Wch) of the neck structures 525 and the manifold 510. The distinction between FIG. 5b and FIG. 4d is that the latter merely discloses forming the chambers 420 with the same length, but FIG. 5b discloses forming the same connection width 530 of the neck structures 525 and the manifold 510 in addition to forming the chambers 520 with the same length.

The fabrication methods for the injection devices illustrated in FIG. 5b and FIG. 4d are similar. The distinction therebetween is merely the pattern formation on a sacrificial layer, for example, after a sacrificial layer is formed on a first plane of the substrate, the sacrificial layer is exposed by a mask having neck structure patterns and chamber patterns, as shown in FIG. 5a, to form a patterned sacrificial layer comprising neck structure patterns and chamber patterns after developing, wherein lengths of the chamber patterns are equal.

After deposition steps for each semiconductor layer are finished, a series of etching steps are performed to finally form a fluid injection device. The chambers 520 and the neck structures 525 are formed by etching, wherein the neck structures 525 are formed between the chambers 520 and the manifold 510 to form the chambers 520 with the same length (Lc), and the connections of the neck structures 525 and the manifold 510 have the same width, as shown in FIG. 5b.

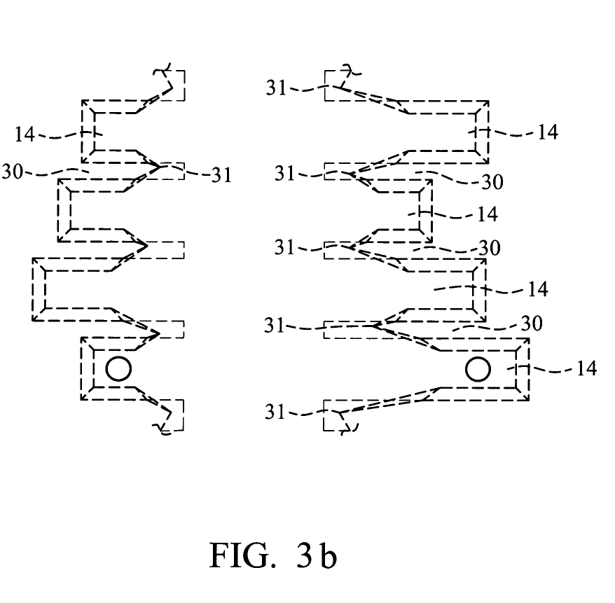

The invention provides a specific connection design such as a manifold-neck structure-chamber on a photomask to form chambers with the same length and solve cross-talk problems by forming connections with the same width between the neck structures and the manifold. Additionally, the invention also prevents the formation of etching peaks due to increasing the isolation area 30 as shown in FIG. 3b.

Referring to FIG. 6b, the third feature of the fluid injection device of the invention is the installation of neck structures 625 with the same length (Ln) between the chambers 620 and the manifold 610 to form chambers 620 with the same length (Lc). The distinction between FIG. 6b and FIG. 5b is that the latter does not set the lengths of the neck structure 525, but FIG. 6b discloses forming the neck structures 625 with the same length.

The fabrication methods for the injection devices illustrated in FIG. 6b and FIG. 5b are similar. The distinction therebetween is merely the pattern formation on a sacrificial layer, for example, after a sacrificial layer is formed on a first plane of the substrate, the sacrificial layer is exposed by a mask having neck structure patterns and chamber patterns, as shown in FIG. 6a, to form a patterned sacrificial layer comprising neck structure patterns and chamber patterns after developing, wherein lengths of the chamber patterns and the neck structure patterns are respectively equal.

After deposition steps for each semiconductor layer are finished, a series of etching steps are performed to finally form a fluid injection device. The chambers 620 and the neck structures 625 are formed by etching, wherein the neck structures 625 are formed between the chambers 620 and the manifold 610 to form the chambers 620 with the same length (Lc), and the lengths thereof are also equal, as shown in FIG. 6b.

The invention provides a specific connection design such as a manifold-neck structure-chamber on a photomask to form chambers with the same length and solve the cross-talk problem and control the flow resistance by forming the neck structures with the same length.

Referring to FIG. 7b, the fourth feature of the fluid injection device of the invention are the installation of the neck structures 725 with the same length (Ln) between the chambers 720 and the manifold 710 to form the chambers 720 with the same length (Lc) and the design of the altered neck structure widths (Wn1˜Wn3) which increase as distances from the chambers 720 to the manifold 710 increase. The distinction between FIG. 7b and FIG. 6b is that the latter does not set the widths of the neck structures 625, but FIG. 7b discloses forming the neck structures 725 with altered widths which increase as distances from the chambers 720 to the manifold 710 increase.

The fabrication methods for the injection devices illustrated in FIG. 7b and FIG. 6b are similar. The distinction therebetween is merely the pattern formation on a sacrificial layer, for example, after a sacrificial layer is formed on a first plane of the substrate, the sacrificial layer is exposed by a mask having neck structure patterns and chamber patterns, as shown in FIG. 7a, to form a patterned sacrificial layer comprising neck structure patterns and chamber patterns after developing, wherein lengths of the chamber patterns and the neck structure patterns are respectively equal, and the widths of the neck structure patterns are increased as distances from the chamber patterns to the subsequently formed manifold increase.

After deposition steps for each semiconductor layer are finished, a series of etching steps are performed to finally form a fluid injection device. The chambers 720 and the neck structures 725 are formed by etching, wherein the neck structures 725 are formed between the chambers 720 and the manifold 710 to form the chambers 720 with the same length (Lc), the lengths thereof are also equal, and the widths of the neck structures 725 are increased as distances from the chambers 720 to the manifold 710 increase, such as Wn3>Wn2>Wn1, as shown in FIG. 7b.

The invention provides a specific connection design such as a manifold-neck structure-chamber on a photomask to form chambers with the same length and effectively control the flow resistance by forming the neck structures with the altered widths, significantly improving the injection quality.

While the invention has been described by way of example and in terms of preferred embodiments, it is to be understood that the invention is not limited to the disclosed embodiments. To the contrary, it is intended to cover various modifications and similar arrangements (as would be apparent to those skilled in the art) Therefore, the scope of the appended claims should be accorded the broadest interpretation so as to encompass all such modifications and similar arrangements.

1. A fluid injection device, comprising:
a substrate;
a structural layer formed on the substrate;
a manifold installed in the substrate to supply fluid;
a plurality of chambers with the same length formed between the substrate and the structural layer to hold injected fluid, wherein the chambers connect with the manifold; and
a plurality of nozzles through the structural layer, connecting the chambers to inject fluid.

2. The fluid injection device as claimed in claim 1, further comprising, a channel installed between the manifold and each chamber.

3. The fluid injection device as claimed in claim 2, wherein a connection width of the channel and the manifold is larger than another connection width of the channel and the chamber.

4. The fluid injection device as claimed in claim 1, wherein distances from the nozzles to the manifold are different.

5. A fluid injection device, comprising:
a substrate;
a structural layer formed on the substrate;
a manifold installed in the substrate to supply fluid;
a plurality of chambers formed between the substrate and the structural layer and connected with the manifold to hold injected fluid, further comprising, a neck structure installed between the manifold and each chamber; and
a plurality of nozzles through the structural layer, connecting the chambers to inject fluid.

6. The fluid injection device as claimed in claim 5, wherein the chambers have the same length.

7. The fluid injection device as claimed in claim 5, wherein the chambers have different lengths.

8. The fluid injection device as claimed in claim 5, wherein the neck structure is rectangular.

9. The fluid injection device as claimed in claim 5, wherein the neck structures have the same length.

10. The fluid injection device as claimed in claim 5, wherein the neck structures have different lengths.

11. The fluid injection device as claimed in claim 5, wherein the neck structures have the same width.

12. The fluid injection device as claimed in claim 5, wherein the neck structures have different widths.

13. The fluid injection device as claimed in claim 5, wherein the neck structure has a width less than the chamber.

14. The fluid injection device as claimed in claim 5, wherein connection widths of the neck structures and the manifold are the same.

15. The fluid injection device as claimed in claim 5, wherein connection widths of the neck structures and the manifold are different.

16. The fluid injection device as claimed in claim 5, wherein distances from the nozzles to the manifold are different.

17. A fluid injection device, comprising:
a substrate;
a structural layer formed on the substrate;
a manifold installed in the substrate to supply fluid;
a plurality of chambers formed between the substrate and the structural layer and connected with the manifold to hold injected fluid, further comprising, a neck structure installed between the manifold and each chamber, wherein the neck structures have different widths which increase as distances from the chambers to the manifold increase; and
a plurality of nozzles through the structural layer, connecting the chambers to inject fluid.

18. The fluid injection device as claimed in claim 17, wherein the chambers have the same length.

19. The fluid injection device as claimed in claim 17, wherein the chambers have different lengths.

20. The fluid injection device as claimed in claim 17, wherein the neck structure is rectangular.

21. The fluid injection device as claimed in claim 17, wherein the neck structures have the same length.

22. The fluid injection device as claimed in claim 17, wherein the neck structures have different lengths.

23. The fluid injection device as claimed in claim 17, wherein the neck structure has a width less than the chamber.

24. The fluid injection device as claimed in claim 17, wherein connection widths of the neck structures and the manifold are the same.

25. The fluid injection device as claimed in claim 17, wherein connection widths of the neck structures and the manifold are different.

26. The fluid injection device as claimed in claim 17, wherein distances from the nozzles to the manifold are different.
